(19) United States
(12) Patent Application Publication
(10) Pub. No.: US 2007/0156386 A1
(43) Pub. Date: Jul. 5, 2007

(54) Linearization of page based memory for increased performance in a software emulated central processing unit

(76) Inventors: Russell W. Guenthner, Glendale, AZ (US); Clinton B. Eckard, McMinnville, TN (US); William J. Brophy, Buena Vista, CO (US); Rodney B. Schultz, Phoenix, AZ (US); F. Michel Brown, Glendale, AZ (US)

Correspondence Address: Dr. Russell W. Guenthner;Bull HN Information Systems Inc. - MS B55, 13430 N. Black Canyon Highway, Phoenix, AZ, 85029, US

(21) Appl. No.: 11/323,439

(22) Filed: Dec. 30, 2005

(51) Int. Cl. G06F 9/455

(52) U.S. Cl. 703/26

(57) ABSTRACT

As fast and powerful commodity processors have been developed, it has become practical to emulate on platforms built using commodity processors the proprietary legacy hardware systems of powerful older computers. High performance is often a key requirement for a system even when built using emulation software. Within the hardware of the legacy system the memory management software and paging hardware is often complex, and takes considerable code in the software emulator to emulate. If the segments of data referenced by a program running under the software emulator can be placed in contiguous linear memory, the memory management software and the work of the software emulator can be reduced to improve performance and reduce complexity of the emulated system.

### FIELD OF THE INVENTION

This invention relates to the art of computer system emulation and, more particularly, to the emulation of a Central Processing Unit and Input/Output system in which the legacy hardware design includes paging, segmentation, or an associative memory mechanism for mapping of a large virtual memory space to a smaller real or physical memory space.

### BACKGROUND OF THE INVENTION

Users of obsolete mainframe computers running a proprietary operating system may have a very large investment in proprietary application software and, further, may be comfortable with using the application software because it has been developed and improved over a period of years, even decades, to achieve a very high degree of reliability and efficiency.

As manufacturers of very fast and powerful commodity processors continue to improve the capabilities of their products, it has become practical to emulate the proprietary operating systems of powerful older computers such that the manufacturers of the older computers can provide new systems which allow the users to continue to use their highly-regarded proprietary software by emulating the older computer.

Accordingly, computer system manufacturers are developing such emulator systems for the users of their older systems, and the emulation process used by a given system manufacturer is itself subject to ongoing refinement and increases in efficiency and reliability.

Some historic computer systems now being emulated by software running on “commodity” processors have achieved performance which is nearly equal to that provided by legacy hardware system designs. An example of such hardware emulation is the Bull HN Information Systems (descended from General Electric Computer Department and Honeywell Information Systems) DPS9000 system which is being emulated by a software package internally called “HELIOS” running on a Bull NovaScale system which is based upon an Intel Itanium 2 Central Processor Unit. The 64-bit Itanium Intel processor is used to emulate the Bull DPS 9000 36-bit memory space and the GCOS 8 instruction set of the DPS 9000. Within the memory space of the emulator, the 36-bit word of the DPS 9000 is stored right justified (least significant bits) in the least significant 36 bits of the “host” (Itanium) 64-bit word. The upper 28 bits of the 64-bit word are typically zero for “legacy” code. Sometimes, certain specific bits in the upper 28 bits of the containing word are used as flags or for other temporary purposes, but in normal operation these bits are usually zero and in any case are always viewed by older programs in the “emulated” view of the world as being non-existent. That is, only the emulation program itself uses these bits.

In the design of the emulator system careful attention is typically devoted to ensuring exact duplication of the legacy hardware behavior so that application programs will run without change and without recompilation. Exact duplication of legacy operation is typically a requirement in order to achieve exactly equivalent results during execution.

To this end, the emulation program for the Central Processor Unit, and also any emulation of the Input/Output system typically includes the processing typically found in the legacy hardware for segmentation, paging and any associative memory processing. This mechanism is that which translates the “virtual address” seen by the application program from the user's point of view into a “real address” which is actually used to directly address the memory system hardware. In most modern computer systems the virtual program visible address space is larger than the real memory space actually available on the computer system.

When the emulation software is itself run under another operating system, such as Linux, the higher level operating system and the underlying hardware it uses itself performs its own functions of segmentation, paging or the implementation of associative memory. This results in the emulation software emulating segmentation, paging and associative memory processing of the legacy system, and then the upper level operating system which is running the emulated system also doing its own segmentation, paging and utilization of an associative memory.

The present invention is directed to removing the unnecessary manipulation of the virtual address by the emulation software system which decreases the host machine cycles required for emulation of each legacy instruction and thus potentially significantly improving the overall performance of the emulated system.

### OBJECTS OF THE INVENTION

It is therefore a broad object of this invention to improve performance of an emulator system by modifying the legacy system's virtual memory system in a manner such that the legacy system's segments and the pages making up those segments are stored linearly in the host system's virtual memory space, thus allowing removal of the paging activity from the requirements of the optimized emulation system software. It is a second broad object of the invention to retain the page and segmentation based reference tables for use by un-optimized system software such that not all pieces of the system software need to be modified to utilize the optimized methods.

### SUMMARY OF THE INVENTION

Briefly, these and other objects of the invention are achieved by an overall approach and mechanisms to support that approach which support a memory structure that eliminates the need for paging actions to be a part of the emulated legacy memory system. A first part of the mechanism is accomplished by placing in linear virtual memory space on the emulation host system all the segments that are a part of a program to be run. A second optional part of the mechanism is to “wire” all emulated memory system data for that program so that all memory system data is always present in the host system's virtual address space. This eliminates the need for any host system paging which may cause unpredictable delays that may be unacceptable to performance in an emulated central processing unit. This also eliminates the hazard of having the host system paging and memory management system remove pieces of the legacy system's memory space from the host system's real memory, which could cause unacceptable delays in processing for emulation of the legacy system's Input/Output system, or prevent a timely response by the emulated legacy Central Processor Unit response to time critical requests.

It is a second part of the invention to implement the linearization of the segments by placing the pages within the segment in sequential linear address space, but to retain the underlying paging mechanisms which reference and manage these pages. This approach allows the legacy operating system, which may be large and complex, to continue to view the segments as a collection of non-linear pages within the normal and historic memory management system, while allowing any chosen pieces of the software or the software emulator itself to not use the paging mechanism and achieve a potential increase in performance. This approach allows the “old” software and any pieces of the operating system from the past to continue to work properly.

There are at least three approaches to achieving the placement of pages within a segment into a linear arrangement. The first approach is when any segment is created to ensure that the pages are placed in linear order at the time the segment is created. This approach may not be easily accomplished within the legacy operating system especially since it requires that a hole of contiguous pages be found in a potentially busy memory system, and so an alternative approach may be needed. A second approach is to create the segment with non-linear pages, and then after the segment is totally in memory to identify a block of real memory for final linear placement of the pages within the segment, and interchange the pages currently within that space with the desired pages until all pages for the segment in question are now linear. This may not be possible instantaneously if some of the pages to be moved are wired or locked in place for I/O operations, or other reasons.

A third approach is to create a space within the legacy system's virtual address space that is reserved only for linear segments, and to manage that space separately. With the large memory spaces available on modern commodity processors this may be the most common and efficient approach.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a high-level block diagram showing a “host” system emulating the operation of a legacy system, running legacy software;

FIG. 2 shows the format of an exemplary simple legacy code instruction that is emulated by emulation software on the host system;

FIG. 3 is a simplified flow chart showing the basic approach to emulating legacy software in a host system;

FIG. 4 is a simplified flow chart including steps for accomplishing the virtual to real address translation in the software emulator of the legacy system which is part of the overall processing required to emulate the processing of each legacy opcode;

FIG. 5 is a block diagram showing an example of paging where the pages of a segment are placed in potentially non-contiguous and non-linear locations within the memory system;

FIG. 6 is a block diagram showing and example of pages of a segment placed in a contiguous address space and also placed linearly;

FIG. 7 is a block diagram shows two ways of addressing the same segment, one piece of un-optimized software utilizing the paging mechanism, and the second and optimized piece of software utilizing a direct calculation from the segment base without paging; and

FIG. 8 is a block diagram showing pages of a segment placed in non-contiguous locations and then swapped with other pages to make them contiguous.

### DESCRIPTION OF THE PREFERRED EMBODIMENT(S)

While the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and operating requirements without departing from those principles.

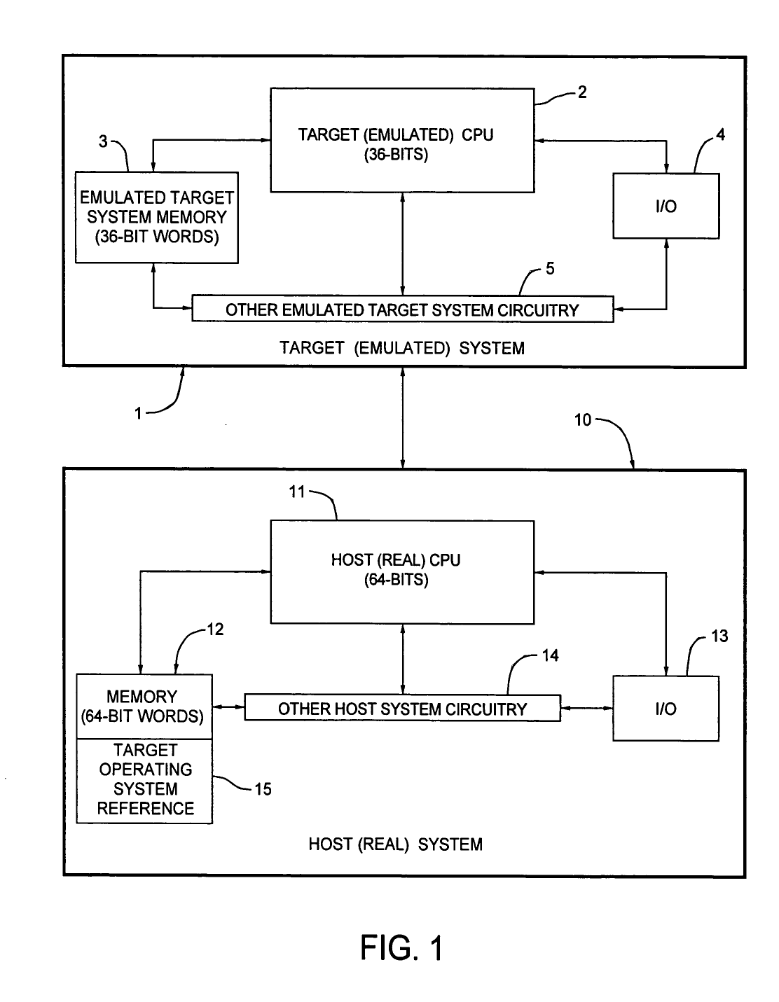

FIG. 1 illustrates an exemplary environment in which the invention finds application. More particularly, the operation of a target (emulated) “legacy” system is emulated by a host (real) system 10. The target system 1 includes an emulated central processing unit (CPU) 2 (which may employ multiple processors), an emulated memory 3, emulated input/output (I/O) 4 and other emulated system circuitry 5. The host (real) system 10 includes a host CPU 11, a host memory 12, host I/O 13 and other host system circuitry 14. The host memory 12 includes a dedicated target operating system reference space 15 in which the elements and components of the emulated system 1 are represented.

The target operating system reference space 15 also contains suitable information about the interconnection and interoperation among the various target system elements and components and a complete implementation in software of the target system operating system commands which includes information on the steps the host system must take to “execute” each target system instruction in a program originally prepared to run on a physical machine using the target system operating system. It can be loosely considered that, to the extent that the target system 1 can be said to “exist” at all, it is in the target operating system reference space 15 of the host system memory 12. Thus, an emulator program running on the host system 2 can replicate all the operations of a legacy application program written in the target system operating system as if the legacy application program were running on a physical target system.

In a current state-of-the-art example chosen to illustrate the invention, a 64-bit Intel Itanium series processor is used to emulate the Bull DPS 9000 36-bit memory space and the instruction set of the DPS 9000 with its proprietary GCOS 8 operating system. Within the memory space of the emulator, the 36-bit word of the DPS 9000 is stored right justified in the least significant 36 bits of the “host” (Itanium) 64-bit word during the emulation process. The upper 28 bits of the 64-bit word are typically zero; however, sometimes, certain specific bits in the “upper” 28 bits of the “containing” word are used as flags or for other temporary purposes. In any case, the upper 28 bits of the containing word are always viewed by the “emulated” view of the world as being non-existent. That is, only the emulation program itself uses these bits or else they are left as all zeroes. Leaving the bits as all zeroes can also be a signal to the software emulator that it is “emulating” a 36-bit instruction, and the non-zero indication would signal a 64-bit instruction.

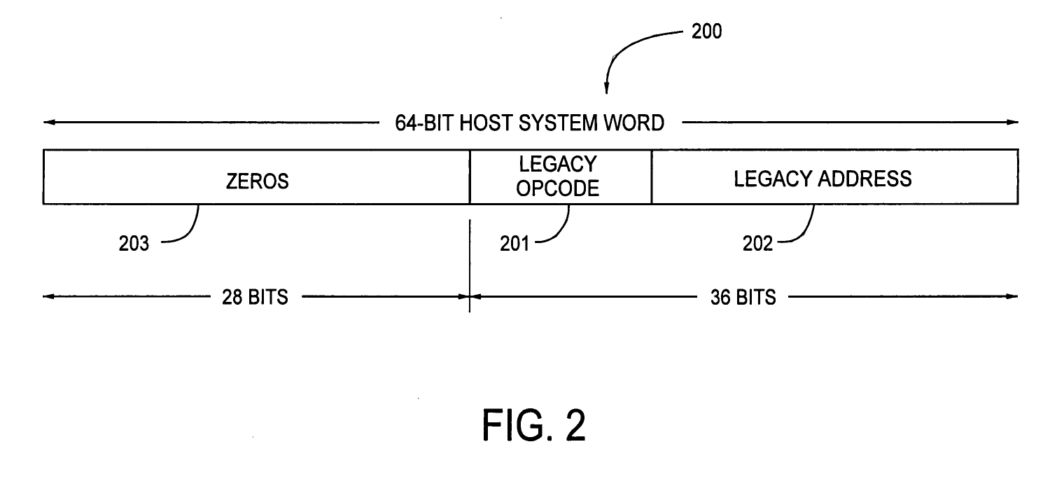

FIG. 2 shows, in a 64-bit host system word 200, the format of a simple 36-bit legacy code instruction word which includes an opcode field 201 and an address or operand field 202 and unused bits which are zeroes 203. Those skilled in the art will appreciate that an instruction word can contain several fields which may vary according to the class of instruction word, but it is the field commonly called the “opcode” which is of particular interest in explaining the present invention. The opcode of the legacy instruction is that which controls the program flow of the legacy program being executed. As a direct consequence the instruction word opcode of each sequential or subsequent legacy instruction controls and determines the overall program flow of the host system emulation program and the program address of the host system code to process each legacy instruction. Thus, the legacy instruction word opcode and the examination and branching of the host system central processor based on the opcode is an important and often limiting factor in determining the overall performance of the emulator. The decision making to transfer program control to the proper host system code for handling each opcode type is unpredictable and dependent on the legacy system program being processed. The order of occurrence and the branching to handle any possible order of instruction opcodes is unpredictable and will often defeat any branch prediction mechanism in the host system central processor which is trying to predict program flow of the emulation program.

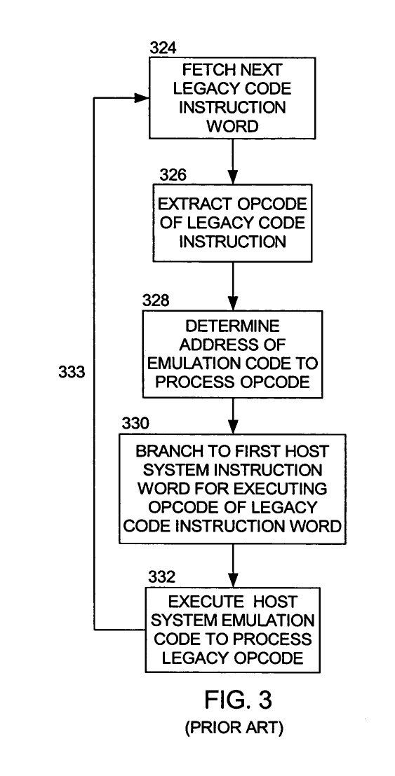

FIG. 3 is a simplified flow chart showing the basic approach to emulating legacy software in a host system. As a first step 324 an emulated instruction word, the legacy code instruction word, is fetched from host system memory. The emulated instruction word is decoded by the emulation software including the extraction of the opcode 326 from the instruction word. This opcode is used to determine the address of the code within the emulation software 328 which will be selected to process that specific opcode. This determination can be made in many ways well known in the art of computer programming. For example, the address can be looked up in a table indexed by the opcode, with the table containing pointers to the routine that will process that particular instruction. An alternative is to arrange the processing code in host system memory such that the address of each piece of opcode processing code can be calculated, rather than looked up in a table. A second alternative commonly used in the high level “C” programming language is to use a “switch” statement to select between alternate execution paths. A third alternative is to use a table of addresses which point to subroutines or functions, and to use the table to look up the address and the make a call to the proper subroutine based upon that address. This third alternative is particularly efficient when the lower level subroutines for handling a specific opcode are written in either “C” or assembly. Continuing as shown in FIG. 3, once the address of the code to process a specific opcode is selected, a branch to the code selected is made 330 with that branch being either a call instruction if the code is implemented as a subroutine, or a simple branch if the code is in the same routine as the branch itself. Then, the actual code to process the instruction as determined by the opcode is executed 332. Finally, once that instruction is processed the code begins the processing of the next instruction 333.

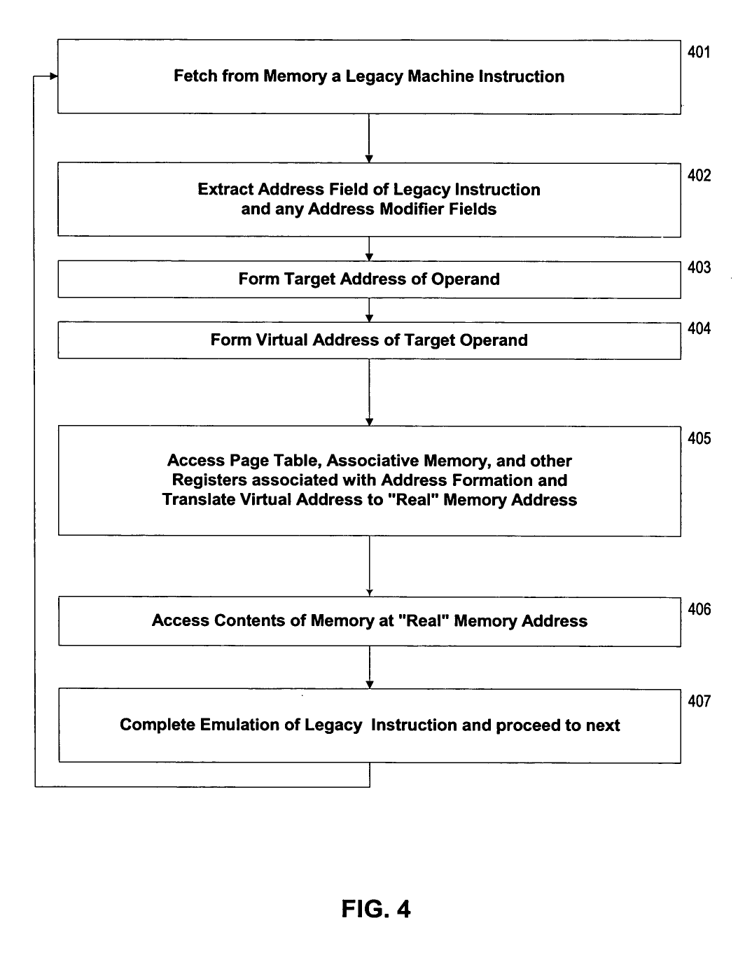

FIG. 4 is a simplified flow chart including steps for accomplishing the virtual to real address translation in the software emulator of the legacy system which is part of the overall processing required to emulate the processing of each legacy opcode. The normal processing of the software emulator begins with the fetch of the legacy instruction word 401. If there is an operand to be fetched, then the address field and any address modifiers which are a part of the instruction word are extracted 402 and utilized to calculate a target address 403 and then the virtual address 404. The virtual address is translated to what is normally known in the target system's memory space as a “real” address 405. The real address is the address in memory after the steps of paging have been applied. Then the software emulator accesses the data from real memory 406 and completes the emulation of the legacy instruction 407. The work associated with the paging and translation of virtual to real addresses is what is intended to be removed from the optimized emulation code as part of the invention.

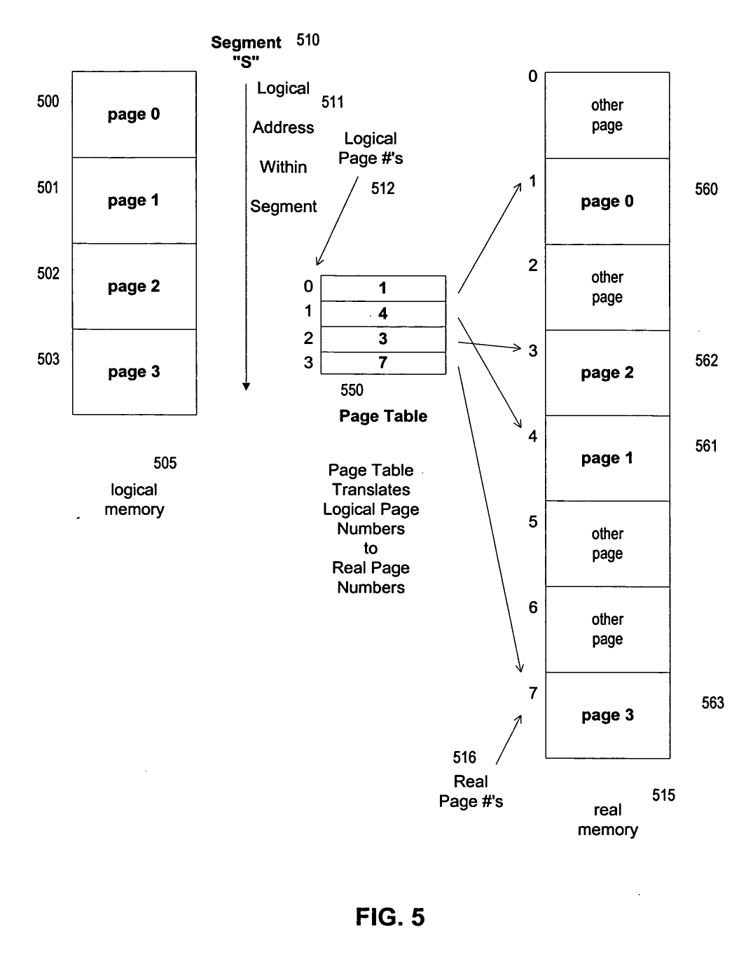

FIG. 5 is a block diagram showing an example of paging with the pages of a segment placed in potentially non-contiguous and non-linear locations within the memory system. For this example, a segment “S” 510 is a logical memory space 505 as viewed by a programmer on the legacy system. Segment “S” is held in pages and is four pages long. The pages are marked as page 0 500, page 1 501, page 2 502, and page 3 503. The pages are viewed by the programmer in logical memory 505 as being in logical order from 0 to 3 with logical page numbers 512 which are 0 to 3, but in real memory space 515 they actually reside in discontiguous places in real memory 515. They are kept accessible in linear perspective by addressing them through a page table 550 which translates the logical address 511 within the segment “S” 510 to a real memory page address 516 in real memory 515. This mechanism is well known in the computer industry and by any person skilled in the art of computer design. In this example, pages 0, 1, 2 and 3 of the segment “S” are scattered in real memory at real memory page addresses 516 numbered 1, 4, 3, and 7 respectively. The pages are located in these real page addresses and marked in the figure a second time with different marking numbers to note their location in “real” memory as 560, 561, 562 and 563 respectively. These pages are not in linear order and are not contiguous in real memory, so the use of the page table 550 is required to locate in real memory any data within the segment.

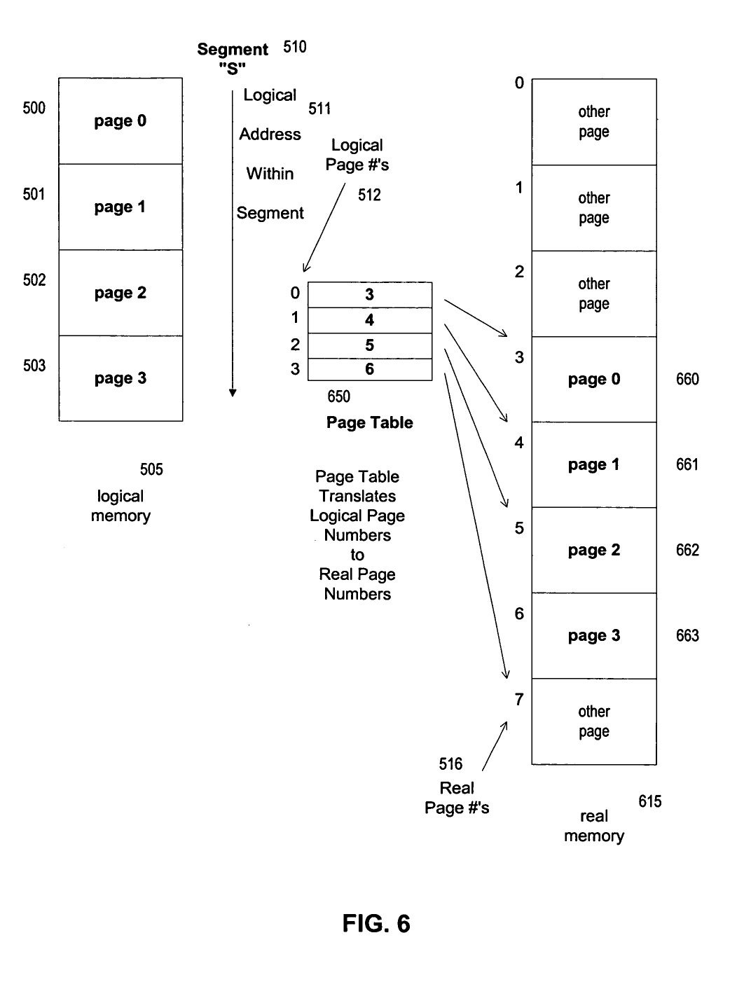

FIG. 6 is a block diagram of the same logical segment shown in FIG. 5 but with the pages of the segment placed in real memory 615 in a contiguous address space and also placed linearly. The mechanisms are exactly the same as described for FIG. 5. except that the pages, and the page table entries which point to the pages are in a different order. The page table in FIG. 5 550 had the pages in real memory pages 1, 4, 3 and 7. The page table in FIG. 6 marked as 650 has the pages in real memory 615 pages 3, 4, 5, and 6. This arrangement puts the pages of the segment “S”, pages 0 to 3 in contiguous and linear real memory space as shown in the diagram of real memory 615. The pages 0 to 3 marked as 500, 501, 502, and 503 are in real memory marked as 660, 661, 662, and 663.

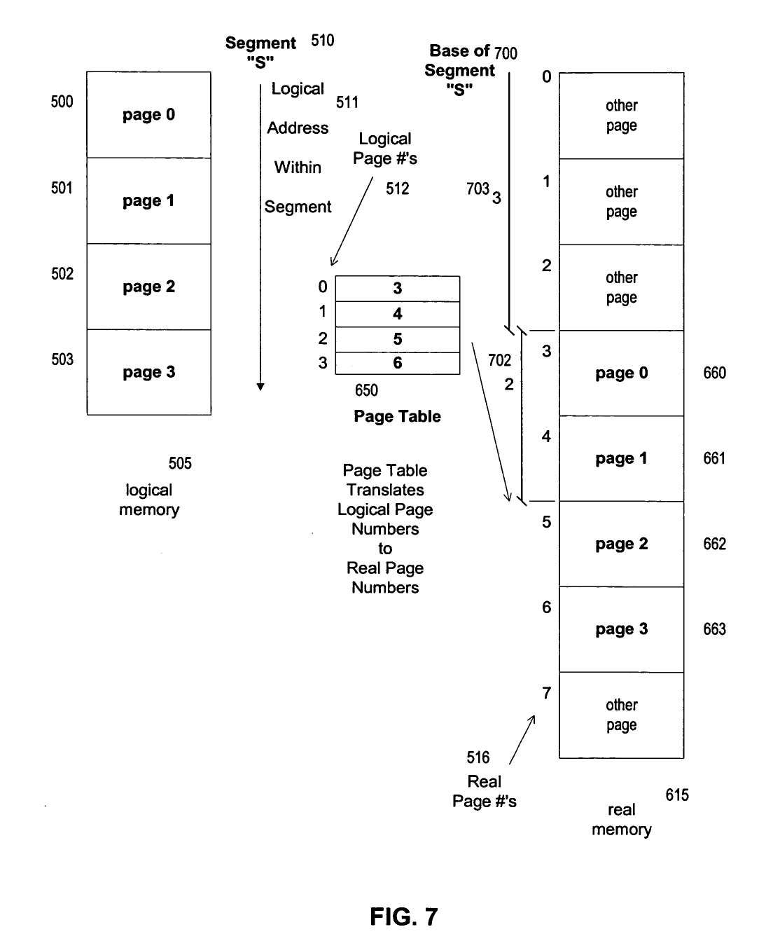

FIG. 7 is a block diagram that shows a mechanism of addressing the same segment in two ways. The first way is already described in the previous figures and is used by un-optimized software utilizing the paging mechanism. The second way allows an optimized piece of software to utilize a direct calculation of the real memory address from the segment base 700 without going through the page table 650. Since the pages are arranged linearly in memory and are contiguous, either approach results in a correct access to the same words of data, but the direct calculation is faster. As an example, utilizing the page table, segment “S” 510 finds page 2 within itself by looking at the page table 650 and finding that page 2 is located in real memory page number 5 which is marked as 662. The same location can be addressed by taking the base address of segment “S” 700 which is assumed to be 3 marked as 703, adding the offset which is the page number 2 marked as 702, with a resultant page number of 3 plus 2 which is 5, which is the same result as going through the page table, but which is much more direct and faster to calculate. Determining the base of segment “S” 700 with its location in real memory beginning at page 3 is a is a part of the addressing mechanism for dividing data into segments which is not part of this invention, and is well known in the art.

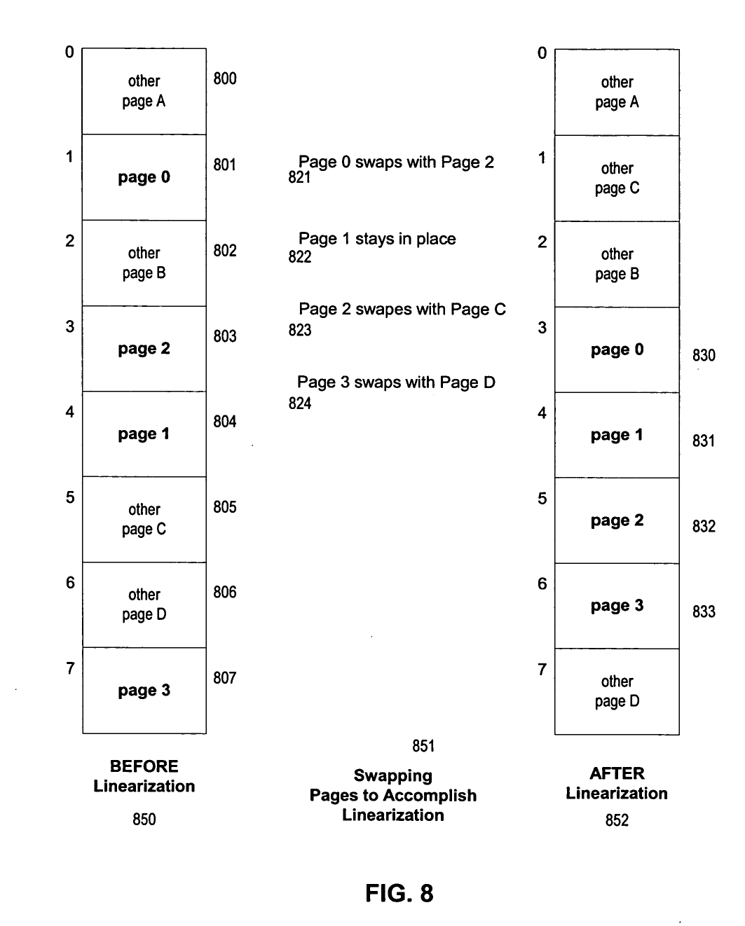

FIG. 8 is a block diagram showing pages of a segment placed in non-contiguous locations and then swapped with other pages to make them contiguous. The purpose of this swapping is to take a segment that was instantiated in memory in either a discontiguous or non-linear manner, and make it both contiguous and linear. The pages of a segment, page 0, 1, 2 and 3 are shown in real memory pages 0 to 7 in the “before” 850 diagram. Pages 0 to 3 are at page locations 1, 4, 3 and 7 respectively marked as 801, 804, 803 and 807 also respectively. Other pages in memory are name “other page A” 800, “other page B” 802, “other page C” 805, and “other page D” 806. In the “before” diagram, page 0 is in real memory page 1, page 1 is in real memory page 4, page 2 is in real memory page 3, and page 3 is in real memory page 7. A swapping procedure that will put the pages into linear, contiguous order is shown 851. The steps for swapping 851 are marked 821, 822, 823, and 824. There are many algorithms that could be chosen to put pages in order. The one chosen here simply steps through the pages and swaps any page not in its place with the one that is the location in which it needs to be when done. Once the swapping is complete, the pages are now in linear order as shown in the “after” memory diagram 852 beginning with page 0 being in real memory page 3 and the others following in sequential order 830, 831, 832, and 833. This mechanism which linearizes a segment may be useful when there is not enough empty contiguous space in memory to simply instantiate a segment linearly, so this approach allows it to be instantiated in the normal non-linear manner and then linearized by swapping.

Thus, while the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and operating requirements without departing from those principles.

It is specifically noted that there are many levels of memory hierarchy in modern computer systems, and the terms for describing the “real” memory address, “logical” memory address, “physical” memory address and other such terms are intended to express the concept of the invention and not to be limiting or literally interpreted. For example, the words “real memory” as visualized at one level of the memory hierarchy may not indeed be the lowest level of the memory hierarchy and various tables and translations of the address can take place in the host system hardware or software beneath what is seen by the programmer or user.

What is claimed is:

1. An apparatus for emulating in software the hardware and operations of a target computer system including:
A) a central processing unit which is part of a host system;
B) a mass memory which is a part of the host system;
C) target system memory contained within said mass memory;
D) an instruction set of the target computer system;
E) software code for emulation of instructions of the target computer system instruction set;
F) the target computer system including a paging mechanism;
G) an operating system for the target computer system including support for memory management utilizing a paging mechanism which allows for discontiguous pages;
H) the target computer system including a mechanism for dividing the memory space referenced by a program into segments; and
I) a mechanism for instantiating pages of a segment into linear and contiguous real memory space.

2. The apparatus of claim 1 including also:
A) a mechanism within the software code for emulation of instructions for accessing data of a program within a segment utilizing the address of that segment's base within the target system memory and an offset within that segment, without reference to a page table.

3. The apparatus of claim 2 including also:
A) an alternate mechanism within the software code for emulation of instructions for accessing data of a program within a segment utilizing a page table.

4. An apparatus for emulating in software the hardware and operations of a target computer system including:
A) a central processing unit which is part of a host system;
B) a mass memory which is a part of the host system;
C) target system memory contained within said mass memory;
D) an instruction set of the target computer system;
E) software code for emulation of instructions of the target computer system instruction set;
F) the target computer system including a paging mechanism;
G) an operating system for the target computer system including support for memory management utilizing a paging mechanism which allows for discontiguous pages;
H) the target computer system including a mechanism for dividing the memory space referenced by a program into segments; and
I) a mechanism for moving the pages of a segment from non-linear discontiguous memory into linear and contiguous memory space.

5. The apparatus of claim 4 including also:
A) a mechanism within the software code for emulation of instructions for accessing data of a program within a segment utilizing the address of that segment's base in target system memory and an offset within that segment, without reference to a page table.

6. The apparatus of claim 4 including also:
A) an alternate mechanism within the software code for emulation of instructions for accessing data of a program within a segment including utilization of a page table.

7. An apparatus for emulating in software the hardware and operations of a target computer system including:
A) a central processing unit which is part of a host system;
B) a mass memory which is a part of the host system;
C) target system memory contained within said mass memory;
D) an instruction set of the target computer system;
E) software code for emulation of instructions of the target computer system instruction set;
F) the target computer system including a paging mechanism;
G) the target computer system including a mechanism for dividing the memory space referenced by a program into segments; and
H) a mechanism within the software emulator for accessing data of a program within a segment utilizing the address of that segment's base in target system memory and an offset within that segment, without reference to a page table.
